(19) United States
(12) Patent Application Publication
(10) Pub. No.: US 2017/0362094 A1
(43) Pub. Date: Dec. 21, 2017

(54) ENERGY EFFICIENT WATER PURIFICATION AND DESALINATION

(71) Applicants: Eugene THIERS, San Mateo, CA (US); Brian BAYLEY, Los Altos, CA (US); Gary LUM, San Jose, CA (US); Sylvan Source, Inc., san Carlos, CA (US)

(72) Inventors: Eugene Thiers, San Mateo, CA (US); Brian Bayley, Los Altos, CA (US); Gary Lum, San Jose, CA (US)

(21) Appl. No.: 15/532,749

(22) PCT Filed: Dec. 3, 2015
(86) PCT No.: PCT/US15/63756

§ 371 Date: Jun. 2, 2017

Related U.S. Application Data
(60) Provisional application No. 62/087,122, filed on Dec. 3, 2014.

(51) Int. Cl. C02F 1/04; C02F 1/20; B01D 1/00; B01D 1/30; B01D 5/00; C02F 103/08

(52) U.S. Cl. CPC C02F 1/043; C02F 1/042; B01D 1/305; B01D 5/0006; C02F 1/20; B01D 1/0011; B01D 5/006; B01D 5/0039; C02F 2103/08; C02F 2201/003; C02F 2303/10

(57) ABSTRACT

A desalination system that can comprise an inlet, an optional preheating stage, multiple evaporation chambers and optional demisters, product condensers, a waste outlet, one or more product outlets, a nested configuration that facilitates heat transfer and recovery and a control system. The control system can permit operation of the purification system continuously with minimal user intervention or cleaning. The desalination system can operate with any number of pre-treatment methods for descaling, and with degassing systems to eliminate or reduce hydrocarbons and dissolved gases. The system is capable of removing, from a contaminated water sample, a plurality of contaminant types including microbiological contaminants, radiological contaminants, metals, and salts.

### CROSS-REFERENCE TO RELATED APPLICATION

This application claims priority to U.S. Provisional Patent Application No. 62/087,122, filed Dec. 3, 2014, and the entire disclosure of that application is incorporated herein by reference.

This invention relates to the field of water purification and desalination. In particular, embodiments of the invention relate to systems and methods of removing essentially all of a broad spectrum of impurities from water in an automated industrial process that requires minimal cleaning or maintenance during the course of several months to several years, with relatively high yields of product water per unit of input water, flexibility with respect to energy sources, compact design with a low industrial footprint, and ultra-low energy requirements.

### BACKGROUND

Water purification technology is rapidly becoming an essential aspect of modern life as conventional water resources become increasingly scarce, municipal distribution systems for potable water deteriorate with age, and increased water usage depletes wells and reservoirs, causing saline water contamination. Additionally, further contamination of water sources is occurring from a variety of activities, which include, for example, intensive agriculture, gasoline additives, and heavy toxic metals. These issues are leading to increasing and objectionable levels of germs, bacteria, salts (e.g. chlorates, perchlorates, arsenic, mercury, and even the chemicals used to disinfect potable water) in the water system.

Furthermore, even though almost three fourths of the earth is covered by oceans, fresh water resources are limited to some 3% of all planetary water and they are becoming scarcer as a result of population growth and climate change. Approximately 69% of all fresh water is held in ice caps and glaciers which, with increased global melting become unrecoverable, so less than 1% is actually available and most of that (over 90%) is ground water in aquifers that are being progressively contaminated by human activities and saline incursions. Thus, there is an urgent need for technology that can turn saline water, including seawater and brine, into fresh water, while removing a broad range of contaminants.

Conventional desalination and water treatment technologies, such as reverse osmosis (RO) filtration, thermal distillation systems like multiple-effect distillation (MED), multiple-stage flash distillation (MSF), or vapor compression distillation (VC) are rarely able to handle the diverse range of water contaminants found in saline environments. Additionally, even though they are commercially available, they often require multiple treatment stages or combination of various technologies to achieve acceptable water quality. RO systems suffer from the requirement of high-water pressures as the saline content increases which render them increasingly expensive in commercial desalination, and they commonly waste more than 50% of the incoming feed water, making them progressively less attractive when water is scarce. Moreover, RO installations produce copious volumes of waste brine that are typically discarded into the sea, thus creating high-saline concentrations that are deadly to fish and shellfish. Less conventional technologies, such as ultraviolet (UV) light irradiation or ozone treatment, can be effective against viruses and bacteria, but seldom remove other contaminants, such as dissolved gases, salts, hydrocarbons, and insoluble solids. Additionally, most distillation technologies, while they may be superior at removing a subset of contaminants are frequently unable to handle all types of contaminants.

Because commercial desalination plants are normally complex engineering projects that require one to three years of construction, they normally are capital intensive and difficult to move from one place to another. Their complexity and reliance on multiple technologies also make them prone to high maintenance costs. Thus, because RO plants are designed to operate continuously under steady pressure and flow conditions, large pressure fluctuations or power interruptions can damage the membranes, which are expensive to replace; that technology requires extensive pre-treatment of the incoming feed water to prevent fouling of the RO membrane.

### SUMMARY

The present invention relates to industrial embodiments for an improved desalination and water purification system. The system can include a desalination section that can combine an inlet, a preheating stage, multiple evaporation chambers and demisters, product condensers, a waste outlet, a product outlet, multiple heat pipes for heat transfer and recovery, and a control system. The control system can permit operation of the purification system continuously with minimal user intervention or cleaning. The desalination system can operate with any number of pre-treatment methods for descaling, and with degassing systems to eliminate or reduce hydrocarbons and dissolved gases. The system is capable of removing, from a contaminated water sample, a plurality of contaminant types including microbiological contaminants, radiological contaminants, metals, and salts, and the like, or any combination thereof. In some embodiments of the system and depending on the salinity of the incoming water stream, the volume of water produced can be between about 20% and in excess of 95% of a volume of input water. The system can comprise a nested arrangement of boiling chambers, condensers, and preheater vessels that is compact in the range of 1,000 gallons per day (gpd) to 50 million gpd of water production.

The desalination section can consist of a nested stack of boilers, condensers, and demisters with an outer preheating vessel. The pre-heating vessel can raise the temperature of the incoming water to near the boiling point and can surround the boilers and condensers, thus greatly reducing thermal wall losses. Water exiting the preheating tank can have a temperature of at least about 90° C. Incoming feed water can enter the preheating tank and can be gradually pre-heated by a combination of heat pipes and surface conductivity until the required temperature is achieved, and can exit the pre-heating tank through an optional external degasser or directly with an inner boiling chamber if there is no need for degassing.

The desalination system has two key characteristics: it is compact and offers a very small footprint. In this context, compact means that the surface to volume ratio is minimized by a nested configuration that can include a cylindrical or rectangular design. Because the distillation stages fit inside each other, the external surface area of the system is minimized with respect to its internal volume. Depending on the number of stages of distillation in the system, the nested configuration can be 2, 3, 4, 5, 6, 7, 8, 9, 10, 11, 12, or more, times more compact than a comparable system consisting or a vertical stack or a horizontal stack of distillation systems.

Similarly, the footprint of an industrial system normally refers to the surface area required for its deployment. Again, a nested configuration minimizes the amount of surface area required since the various stages of distillation and condensation fit inside each other. Naturally, the footprint of a system varies with its industrial capacity. In the range of 100,000 gallons/day (gpd) up to 50 million gpd of product water and depending on the number of distillation stages, the footprint of a nested configuration can be 2, 3, 4, 5, 6, 7, 8, 9, 10, 11, 12, or more, times smaller than a comparable system consisting or a vertical stack or a horizontal stack of distillation systems.

The production capacity of the system which is expressed in terms of gpd of product water refers to the volume of clean water produced from a contaminated stream. Accordingly, production capacity is a function of the level of contaminants present in the feedwater. Thus, in the case of seawater and without a need for degassing, the amount of product water recovered can be as high as 86% of the volume of incoming seawater. For higher salinities, the recovery of product water can be significantly lower, of the order of 20%, and for light brackish waters as high as 98-99%.

The small footprint and compact nature of a nested configuration are directly related to the energy requirements to drive the system. Since, the nested configuration minimizes the external surface area, it follows that thermal wall losses are also minimized. Thus, depending on the scale of the nested configuration, energy loses can be 5%, 10%, 20%, 30%, 40%, 50%, 60%, 70%, 80%, or more, smaller than a comparable system consisting or a vertical stack or a horizontal stack of distillation systems. With minimal energy losses, energy efficiency becomes primarily a function of the number of distillation stages. For example, with 10 treatment stages, energy efficiency becomes 10 times greater than for a single distillation stage.

A degasser, which is placed adjacent to the desalination system, can remove gases and organic contaminants that may be volatile or non-volatile by means of counter-current stripping of the incoming water against low-pressure steam or hot gases. The degasser can be in any orientation, having an entry point and an exit point. Pre-heated water can enter the degasser at its entry point, and degassed water exits the degasser at another point. In the system, steam from the highest evaporation chamber can enter the degasser at a distance from the input point of feed water, and can exit the degasser proximate to the entry point of feed water. The degasser can include a matrix adapted to facilitate mixing of water and steam, stripping the inlet water of essentially all organics, volatiles, and gasses by counter-flowing the inlet water against an opposite directional flow of a gas in a degasser. The gas can be, for example, steam, air, nitrogen, natural gas, CO₂, and the like, or any combination thereof. The matrix can include substantially spherical particles. However, the matrix can also include non-spherical particles. The matrix can include particles having a size selected to permit uniform packing within the degasser. The matrix can also include particles of distinct sizes, and the particles can be arranged in the degasser in a size gradient. Water can exit the degasser, substantially free of organics and volatile gases.

The central area of the nested arrangement can provide the heat energy for the entire system, and can consist of a condenser chamber operating with low-pressure waste steam, or it can be a combustion chamber that operates with any type of fuel, various types of waste heat from such sources as geothermal or nuclear power plants, or a vessel that absorbs heat from a working fluid from recuperators, solar heaters, or economizers, or the like.

Pre-treated water can be first pre-heated to near the boiling point and either enters a degasser where gases and hydrocarbons are removed, or directly enters an inner boiler chamber where a portion of the incoming water is turned into steam; a portion of the steam produced in the inner boiler may be used to provide the required steam for degassing, while the balance enters a demister that removes entrained micro-droplets and is condensed into pure water in a condenser chamber immediately surrounding such boiler. As part of the incoming water in the inner boiler evaporates, the balance of the water can become progressively more concentrated in soluble salts, and continuously flows outward into a series of outer boilers until it exits the outermost boiler as a heavy brine at near the solubility limit of the salt solution.

Concurrent with incoming water flowing outward, heat can be provided at the central area of the nested arrangement and is progressively transferred outwards by means of heat pipes. Heat pipes are highly efficient enthalpy transfer devices that operate with small temperature difference between their hot and cold ends. A number of heat pipes can transfer the heat provided at the central vessel to the inner boiler. The steam produced at the inner boiler can be largely recovered as the heat of condensation in the condenser that surrounds the inner boiler, where another set of heat pipes transfers that heat to a concentric outer boiler, thus progressively re-using the heat for multiple evaporation and condensation chambers.

### BRIEF DESCRIPTION OF THE DRAWINGS

FIG. 1 is a diagram of a nested configuration.

FIG. 2 is a schematic view of a nested configuration with concentric vessels.

FIG. 3 is an elevation view of a nested configuration.

FIG. 4 is a diagram of an optional assembly of boilers and condensers.

FIG. 5 is a Fermat spiral option for a nested configuration.

FIG. 6 is an optional arrangement of boilers, condensers and preheating vessels in a nested configuration.

FIG. 7 is an alternative embodiment for a nested configuration.

FIG. 8 is a rectangular embodiment of a nested configuration

FIG. 9 shows an alternative view of a nested configuration.

FIG. 10 is an optional method of securing thin-plate vessels in a nested configuration.

### DETAILED DESCRIPTION

Thermal distillation systems, such as those described by LeGolf et. al. (U.S. Pat. No. 6,635,150 B1), include multiple effect distillation (MED) system which rely on multiple evaporation and condensation steps that operate under vacuum in order to effect evaporation at temperatures lower than the normal point of boiling of water. Such technologies are commercially used for desalination in various countries, but they all operate according to different physico-chemical principles. For example, MED systems, as well as multiple stage flash (MSF) and vapor compression (VC) all require vacuum, which determines that the product water is not sterilized because evaporation occurs at temperatures lower than those needed for sterilization; also, vacuum systems tend to leak and require mechanical reinforcements. In addition, heat transfer and heat recovery in MED, MSF, and VC systems involve heat exchange across membranes or thin metal surfaces, but heat exchangers are prone to fouling and scale formation and require frequent maintenance.

More recently, Thiers (U.S. Pat. No. 8,771,477 B2; USPTO application Ser. No. 14/309,722; and WO 2013/036804 PCT/US2012/054221) described large scale embodiments for a desalination system based on a vertical arrangement of distillation stages that reuses the heat of evaporation multiple times. However, even though the embodiments described by Thiers for a large-scale desalination and water treatment are quite efficient from an energy consumption standpoint and are significantly more efficient than conventional desalination technologies (i.e., RO, and thermal distillation systems like MSF, MED and VC)), those configurations retain substantial surface area which can lead to undesirable thermal wall losses. There is a need for industrial configurations that minimize surface area and industrial footprint and, thus, further optimize energy consumption.

Numerous pre-treatment methods are currently being used for reducing scale-forming compounds prior to water treatment and desalination. Some are based on chemical precipitation of calcium, magnesium and similar divalent cations (e.g., Thiers WO 2010/118425 A1/PCT US2010/030759), others rely on ion exchange, and still others utilize electromagnetic activation for water softening. In general, the selection of pre-treatment method is site and industry specific, and the present invention can operate with any of them.

There is a need for inexpensive and effective desalination and water treatment systems that are continuous and largely self-cleaning, that resist corrosion and scaling, that are modular and thus, compact, that recover a major fraction of the input water while producing a highly concentrated waste brine that crystallizes into a solid salt cake, and that are relatively inexpensive and low-maintenance.

Embodiments of the invention are disclosed herein, in some cases in exemplary form or by reference to one or more Figures. However, any such disclosure of a particular embodiment is exemplary only, and is not indicative of the full scope of the invention.

Embodiments of the invention include systems, methods, and apparatus for water purification and desalination. Some embodiments provide broad spectrum water purification that is fully automated and that does not require cleaning or user intervention other than regular or scheduled maintenance over very long periods of time. For example, systems disclosed herein can run without user control or intervention for 1, 2, 4, 6, 8, 10, or 12 months, or longer. In preferred embodiments, the systems can run automatically for 1, 2, 3, 4, 5, 6, 7, 8, 9, 10, 11, 12, 13, 14, or 15 years, or more.

Embodiments of the invention thus provide a water purification and desalination system including at least an inlet for saline water, contaminated water, or seawater, a preheater, an optional degasser, one or more evaporation chambers, one or more optional demisters, one or more product condensers with one or more product outlets, a waste outlet, and a control system, wherein product water exiting the outlet(s) is substantially pure, and wherein the control system permits operation of the purification system continuously without requiring user intervention. In some embodiments, the volume of product water produced is at least about 20, 25, 30, 35, 40, 45, 50, 55, 60, 65, 70, 75, 80, 85, 90, 95, 96, 97, 98, or 99%, or more, of the volume of input water. Thus the system is of great benefit in conditions in which there is relatively high expense or inconvenience associated with obtaining inlet water and/or disposing of wastewater. The system is significantly more efficient in terms of its production of product water per unit of input water or wastewater, than many other systems.

### Water Purity and Product Water Quality

Substantially pure water can be, in some embodiments, water that meets any of the following criteria: water purified to a purity, with respect to any contaminant, that is at least 25, 30, 35, 40, 45, 50, 55, 60, 65, 70, 75, 80, 85, 90, 95, 100, 125, 150, 175, 200, 250, 500, 750, 1000, or more, times greater purity than the inlet water. In other embodiments, substantially pure water is water that is purified to one of the foregoing levels, with respect to a plurality of contaminants present in the inlet water. That is, in these embodiments, water purity or quality is a function of the concentration of an array of one or more contaminants, and substantially pure water is water that has, for example, a 25-fold or greater ratio between the concentration of these contaminants in the inlet water as compared to the concentration of the same contaminants in the product water.

In other embodiments, water purity can be measured by conductivity, where ultrapure water has a conductivity typically less than about 1 μSiemens, and distilled water typically has a conductivity of about 5. In such embodiments, conductivity of the product water is generally between about 1 and 7, typically between about 2 and 6, preferably between about 2 and 5, 2 and 4, or 2 and 3. Conductivity is a measure of total dissolved solids (TDS) and is a good indicator of water purity with respect to salts, ions, minerals, and the like.

Alternatively, water purity can be measured by various standards such as, for example, current U.S. Environmental Protection Agency (EPA) standards as listed in Table 1 and Table 2, as well as other accepted standards as listed in Table 2. Accordingly, preferred embodiments of the invention are capable of reducing any of one or more contaminants from a broad range of contaminants, including, for example, any contaminant(s) listed in Table 1, wherein the final product water has a level for such contaminant(s) at or below the level specified in the column labeled “MCL” (maximum concentration level) where the inlet water has a level for such contaminant(s) that is up to about 25-fold greater than the specified MCL. Likewise, in some embodiments and for some contaminants, systems of the invention can remove contaminants to MCL levels when the inlet water has a 30-, 40-, 50-, 60-, 70-, 80-, 90-, 100-, 150-, 250-, 500-, 1000-, or 20000-fold or more; higher contamination than the MCL or the product water.

While the capacity of any system to remove contaminants from inlet water is to some extent a function of the total impurity levels in the inlet water, systems of the invention are particularly well suited to remove a plurality of different contaminants, of widely different types, from a single feed stream, producing water that is comparable to distilled water and is in some cases comparable to ultrapure water. It should be noted that the “Challenge Water” column in Table 1 contains concentration levels for contaminants in water used in EPA tests. Some embodiments of water purification systems of the invention typically can remove much greater amounts of initial contaminants than the amounts listed in this column. However, of course, contaminant levels corresponding to those mentioned in the “Challenge Water” column are likewise well within the scope of the capabilities of embodiments of the invention.

TABLE 1

| | | | | Challenge |
|---|---|---|---|---|
| | Units | Protocol | MCL | Water |
| Metals | | | | |
| Aluminum | ppm | | 0.2 | 0.6 |
| Antimony | ppm | | 0.006 | 0.1 |
| Arsenic | ppm | | 0.01 | 0.1 |
| Beryllium | ppm | | 0.004 | 0.1 |
| Boron | ppb | | | 20 |
| Chromium | ppm | | 0.1 | 0.1 |
| Copper | ppm | | 1.3 | 1.3 |
| Iron | ppm | | 0.3 | 8 |
| Lead | ppm | | 0.015 | 0.1 |
| Manganese | ppm | | 0.05 | 1 |
| Mercury | ppm | | 0.002 | 0.1 |
| Molybdenum | ppm | | | 0.01 |
| Nickel | ppm | | | 0.02 |
| Silver | ppm | | 0.1 | 0.2 |
| Thallium | ppm | | 0.002 | 0.01 |
| Vanadium | ppm | | | 0.1 |
| Zinc | ppm | | 5 | 5 |
| Subtotal of entire mix | | | | 36.84 |
| Inorganic salts | | | | |
| Bromide | ppm | | | 0.5 |
| Chloride | ppm | | 250 | 350 |
| Cyanide | ppm | | 0.2 | 0.4 |
| Fluoride | ppm | | 4 | 8 |
| Nitrate, as NO3 | ppm | | 10 | 90 |
| Nitrite, as N2 | ppm | | 1 | 2 |
| Sulfate | ppm | | 250 | 350 |
| Subtotal of entire mix | | | | 800.9 |
| Fourth Group: 2 Highly volatile | | | | |
| VOCs + 2 non-volatiles | | | | |
| Heptachlor | ppm | EPA525.2 | 0.0004 | 0.04 |
| Tetrachloroethylene-PCE | ppm | EPA524.2 | 0.00006 | 0.02 |
| Epichlorohydrin | ppm | | 0.07 | 0.2 |
| Pentachlorophenol | ppm | EPA515.4 | 0.001 | 0.1 |
| Subtotal of entire mix | | | | 0.36 |
| Fifth Group: 2 Highly volatile | | | | |
| VOCs + 2 non-volatiles | | | | |
| Carbon tetrachloride | ppm | EPA524.2 | 0.005 | 0.01 |
| m,p-Xylenes | ppm | EPA524.2 | 10 | 20 |
| Di(2-ethylhexyl) adipate | ppm | EPA525.2 | 0.4 | 0.8 |
| Trichloro acetic acid | ppm | SM6251B | 0.06 | 0.12 |
| Subtotal of entire mix | | | | 21.29 |
| Sixth Group: 3 Highly volatile | | | | |
| VOCs + 3 non-volatiles | | | | |
| 1,1-dichloroethylene | ppm | | 0.007 | 0.15 |
| Ethylbenzene | ppm | EP524.2 | 0.7 | 1.5 |
| Aldrin | ppm | EPA505 | 0.005 | 0.1 |
| Dalapon (2,2,-Dichloropropionic acid) | ppm | EPA515.4 | 0.2 | 0.4 |
| Carbofuran (Furadan) | ppm | EPA531.2 | 0.04 | 0.1 |
| 2,4,5-TP (silvex) | ppm | EPA515.4 | 0.05 | 0.1 |
| Subtotal of entire mix | | | | 2.35 |
| Seventh Group: 3 Highly volatile | | | | |
| VOCs+ 3 non-volatiles | | | | |
| Trichloroethylene—TCE | ppm | EPA524.2 | 0.005 | 0.1 |
| Toluene | ppm | EPA524.2 | 1 | 2 |
| 1,2,4 Trichlorobenzene | ppm | EPA524.2 | 0.07 | 0.15 |
| 2,4-D | ppm | EPA515.4 | 0.07 | 0.15 |
| Alachlor (Alanex) | ppm | EPA525.2 | 0.002 | 0.1 |
| Simazine | ppm | EPA525.2 | 0.004 | 0.1 |
| Subtotal of entire mix | | | | 2.6 |
| Eighth Group: 3 Highly volatile | | | | |
| VOCs + 3 non-volatiles | | | | |
| Vinylchloride (chloroethene) | ppm | EPA524.2 | 0.002 | 0.1 |
| 1,2-dichlorobenzene (1,2 DCB) | ppm | EPA524.2 | 0.6 | 1 |
| Chlorobenzene | ppm | EPA524.2 | 0.1 | 0.2 |
| Atrazine | ppm | EPA525.2 | 0.003 | 0.1 |
| Endothal | ppm | EPA548.1 | 0.01 | 0.2 |
| Oxamyl (Vydate) | ppm | EPA531.2 | 0.2 | 0.4 |
| Subtotal of entire mix | | | | 2 |
| Ninth Group: 3 Highly volatile | | | | |
| VOCs + 3 non-volatiles | | | | |
| Styrene | ppm | EPA524.2 | 0.1 | 1 |
| Benzene | ppm | EPA524.2 | 0.005 | 0.2 |
| Methoxychlor | ppm | EPA525.2/505 | 0.04 | 0.1 |
| Glyphosate | ppm | EPA547 | 0.7 | 1.5 |
| Pichloram | ppm | EPA515.4 | 0.5 | 1 |
| 1,3-dichlorobenzene (1,3 DCB) | ppm | EPA524.2 | 0.075 | 0.15 |
| Subtotal of entire mix | | | | 3.95 |
| Tenth Group: 3 Highly volatile | | | | |
| VOCs + 3 non-volatiles | | | | |
| 1,2-dichloropropane (DCP) | ppm | EPA524.2 | 0.005 | 0.1 |
| Chloroform | ppm | EPA524.2 | 80 | 0.1 |
| Bromomethane (methyl bromide) | ppm | EPA524.2 | | 0.1 |
| PCB1242 Arochlor | ppb | EPA 505 | 0.5 | 1 |
| Chlordane | ppm | EPA525.2/505 | 0.002 | 0.2 |
| MEK-Methylehtylketone (2-butanone) | ppb | EPA524.2 | | 0.2 |
| Subtotal of entire mix | | | | 1.7 |
| Eleventh Group: 4 volatile | | | | |
| VOCs +5 non-volatile PCBs | | | | |
| 2,4-DDE (dichlorodiphenyl | | | | |
| dichloroethylene) | ppm | EPA525.2 | | 0.1 |
| Bromodichloromethane | ppb | EPA524.2 | 80 | 0.1 |
| 1,1,1-Trichloroethane (TCA) | ppm | EPA524.2 | 0.2 | 0.4 |
| Bromoform | ppm | EPA524.2 | 80 | 0.1 |
| PCB 1221 Arochlor | ppm | EPA 505 | 0.5 | 0.05 |
| PCB1260 Arochlor | ppm | EPA 505 | 0.5 | 0.05 |
| PCB 1232 Arochlor | ppm | EPA 505 | 0.5 | 0.05 |
| PCB 1254 Arochlor | ppm | EPA 505 | 0.5 | 0.05 |
| PCB1016 Arochlor | ppm | EPA 505 | 0.5 | 0.05 |
| Subtotal of entire mix | | | | 0.95 |
| Group No 12: 5 volatile VOCs + 5 | | | | |
| non-volatile PCBs | | | | |
| dichloromethane (DCM) | | | | |
| Methylenechloride | ppm | EPA524.2 | 0.005 | 0.1 |
| 1,2-dichloroethane | ppm | | 0.005 | 0.1 |
| Lindane (gamma BHC) | ppm | EPA525.2 | 0.0002 | 0.05 |
| Benzo(a) pyrene | ppm | EPA525.2 | 0.0002 | 0.05 |
| Endrin | ppm | EPA525.2/505 | 0.002 | 0.05 |
| 1,1,2-Trichloroethane (TCA) | ppm | EPA524.2 | 0.005 | 0.05 |
| MTBE | ppm | EPA524.2 | | 0.05 |
| Ethylene dibromide—EDB | ppm | EPA504.1 | 0.00005 | 0.05 |
| Dinoseb | ppm | EPA515.4 | 0.007 | 0.05 |
| Di(2-ethylhexyl) phthalate (DEHP) | ppm | EPA525.2 | 0.006 | 0.05 |
| Subtotal of entire mix | | | | 0.5 |
| Group No 13: Balance of 6 VOCs | | | | |
| Chloromethane (methyl chloride) | ppm | EPA524.2 | | 0.1 |
| Toxaphene | ppm | EPA 505 | 0.003 | 0.1 |
| trans-1,2-dichloroethylene | ppm | EPA524.2 | 0.1 | 0.2 |
| Dibromochloromethane | ppm | EPA524.2 | 80 | 0.05 |
| cis-1,2-dichloroethylene | ppm | EPA524.2 | 0.07 | 0.05 |
| 1,2-Dibromo-3-Chloro propane | ppm | EPA504.1 | 0.0002 | 0.05 |

Determination of water purity and/or efficiency of purification performance can be based upon the ability of a system to remove a broad range of contaminants. For many biological contaminants, the objective is to remove substantially all live contaminants. Table 2 lists additional common contaminants of source water and standard protocols for testing levels of the contaminants. The protocols listed in Tables 1 and 2, are publicly available at hypertext transfer protocol www.epa.gov/safewater/mcl.html#mcls for common water contaminants; Methods for the Determination of Organic Compounds in Drinking Water, EPA/600/4-88-039, December 1988, Revised, July 1991. Methods 547, 550 and 550.1 are in Methods for the Determination of Organic Compounds in Drinking Water—Supplement I, EPA/600-4-90-020, July 1990. Methods 548.1, 549.1, 552.1 and 555 are in Methods for the Determination of Organic Compounds in Drinking Water—Supplement II, EPA/600/R-92-129, August 1992. Methods 502.2, 504.1, 505, 506, 507, 508, 508.1, 515.2, 524.2 525.2, 531.1, 551.1 and 552.2 are in Methods for the Determination of Organic Compounds in Drinking Water—Supplement III, EPA/600/R-95-131, August 1995. Method 1613 is titled “Tetra-through OctaChlorinated Dioxins and Furans by Isotope-Dilution HRGC/HRMS”, EPA/821-B-94-005, October 1994. Each of the foregoing is incorporated herein by reference in its entirety.

TABLE 2

| | | Protocol |
|---|---|---|
| 1 | Metals & Inorganics | |
| | Asbestos | EPA 100.2 |
| | Free Cyanide | SM 4500CN-F |
| | Metals-Al, Sb, Be, B, Fe, Mn, Mo, Ni, Ag, Tl, V, | EPA 200.7/200.8 |
| | Zn | |
| | Anions-NO₃—N, NO₂—N, Cl, SO₄, | EPA 300.0A |
| | Total Nitrate/Nitrite | |
| | Bromide | EPA 300.0/300.1 |
| | Turbidity | EPA 180.1 |
| 2 | Organics | |
| | Volatile Organics-VOASDWA list + | EPA 524.2 |
| | Nitrozbenzene | |
| | EDB & DBCP | EPA 504.1 |
| | Semivolatile Organics-ML525 list + EPTC | EPA 525.2 |
| | Pesticides and PCBs | EPA 505 |
| | Herbicides-Regulated/Unregulated compounds | EPA 515.4 |
| | Carbamates | EPA 531.2 |
| | Glyphosate | EPA 547 |
| | Diquat | EPA 549.2 |
| | Dioxin | EPA 1613b |
| | 1,4-Dioxane | EPA 8270m |
| | NDMA-2 ppt MRL | EPA 1625 |
| 3 | Radiologicals | |
| | Gross Alpha & Beta | EPA 900.0 |
| | Radium 226 | EPA 903.1 |
| | Uranium | EPA 200.8 |
| 4 | Disinfection By-Products | |
| | THMs/HANs/HKs | EPA 551.1 |
| | HAAs | EPA 6251B |
| | Aldehydes | SM 6252m |
| | Chloral Hydrate | EPA 551.1 |
| | Chloramines | SM 4500 |
| | Cyanogen Chloride | EPA 524.2m |

TABLE 3
Exemplary contaminants for system verification

| | | MCLG¹ | |
|---|---|---|---|
| 1 | Metals & Inorganics | | |
| | Asbestos | <7 | MFL² |
| | Free Cyanide | <0.2 | ppm |
| | Metals - Al, Sb, Be, B, Fe, Mn, Mo, Ni, Ag, Tl, V, | 0.0005 | ppm |
| | Zn | | |
| | Anions-NO₃—N, NO₂—N, Cl, SO₄, | <1 | ppm |
| | Total Nitrate/Nitrite | | |
| | Turbidity | <0.3 | NTU |
| 2 | Organics | | |
| | Volatile Organics-VOASDWA list + Nitrobenzene | | |
| | EDB & DBCP | 0 | ppm |
| | Semivolatile Organics-ML525 list + EPTC | <0.001 | ppm |
| | Pesticides and PCBs | <0.2 | ppb |
| | Herbicides-Regulated/Unregulated compounds | <0.007 | ppm |
| | Glyphosate | <0.7 | ppm |
| | Diquat | <0.02 | ppm |
| | Dioxin | 0 | ppm |
| 3 | Radiologicals | | |
| | Gross Alpha & Beta | <5 | pCi/l³ |
| | Radium 226 | 0 | pCi/l³ |
| | Uranium | <3 | ppb |
| 4 | Disinfection By-Products | | |
| | Chloramines | 4 | ppm |
| | Cyanogen Chloride | 0.1 | ppm |
| 5 | Biologicals | | |

| | |
|---|---|
| Cryptosporidium | 0⁴ |
| Giardia lamblia | 0⁴ |
| Total coliforms | 0⁴ |

¹MCLG = maximum concentration limit guidance
²MFL = million fibers per liter
³pCi/l = pico Curies per liter
⁴Substantially no detectable biological contaminants

### Water Pre-Treatment

The objective of the pre-treatment system is to reduce scale-forming compounds to the level they will not interfere by forming scale in subsequent treatment, particularly during desalination. Water hardness is normally defined as the amount of calcium (Ca⁺⁺), magnesium (Mg⁺⁺), and other divalent ions that are present in the water, and is normally expressed in parts per million (ppm) of these ions or their equivalent as calcium carbonate (CaCO₃). Scale forms because the water dissolves carbon dioxide from the atmosphere and such carbon dioxide provides carbonate ions that combine to form both, calcium and magnesium carbonates; upon heating, the solubility of calcium and magnesium carbonates markedly decreases and they precipitate as scale. In reality, scale comprises any chemical compound that precipitates from solution. Thus iron phosphates or calcium sulfate (gypsum) also produce scale. Additional information regarding pre-treatment is provided by Thiers WO 2010/118425 A1/PCT US2010/030759 which is incorporated herein by reference in its entirety.

Conventional descaling technologies include chemical and electromagnetic methods. Chemical methods utilize either pH adjustment, chemical sequestration with polyphosphates, zeolites and the like, or ionic exchange, and typically combinations of these methods. Normally, chemical methods aim at preventing scale from precipitating by lowering the pH and using chemical sequestration, but they are typically not 100% effective. Electromagnetic methods rely on the electromagnetic excitation of calcium or magnesium carbonate, so as to favor crystalline forms that are non-adherent. For example, electromagnetic excitation favors the precipitation of aragonite rather than calcite, and the former is a softer, less adherent form of calcium carbonate. However, electromagnetic methods are only effective over relatively short distance and residence times. Ion exchange, as the name implies, exchanges certain ions for others and include cationic ion exchange resins that exchange cations, such as calcium or magnesium for sodium, or anionic ion exchange resins that exchange anions, such as chlorides or sulfates.

### Overall Description of Water Desalination System

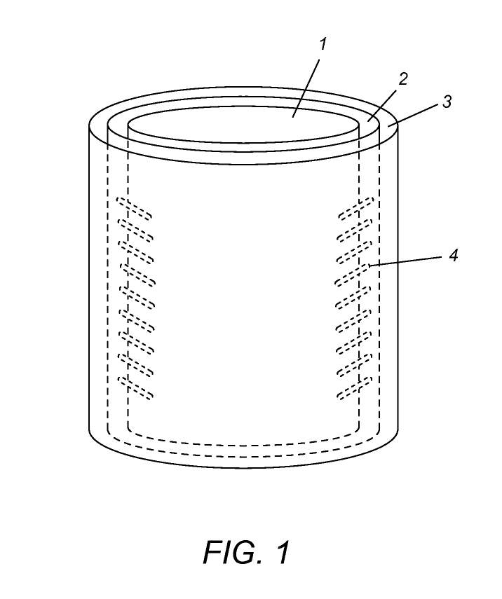

FIG. 1 illustrates a simplified diagram of the water purification and desalination system which provides a nested arrangement of boilers (2) and condensers (3), with a central heat input area (1) and multiple heat pipes (4) that transfer heat from the condensation of steam in a condenser to the adjacent boiler that surrounds it. Various alternative configurations to the concentric nested arrangement are possible to those skilled in the art, such as, for example, a nested arrangement of concentric rectangular boilers, condensers, and preheater vessels, and the like.

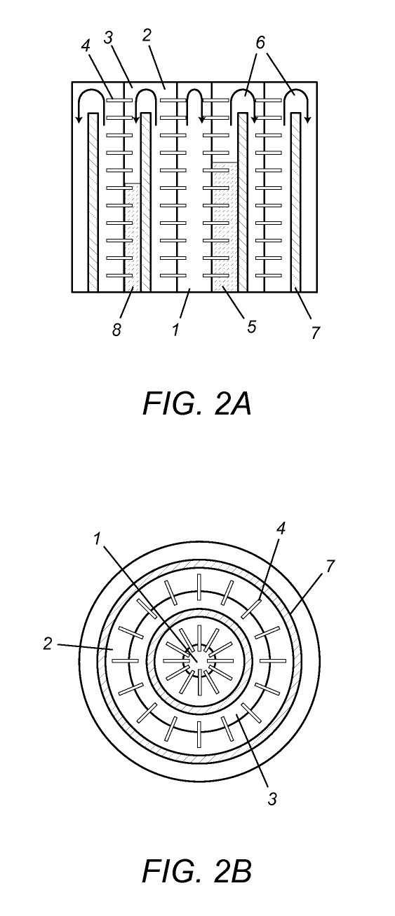

FIG. 2 provides a cross-sectional (a) and a plan view (b) of a nested concentric arrangement of boilers (2), condensers (3), heat pipes (4), a central heat input area (1), contaminated saline input water (5), steam (6) that evaporates in the boiler and is cleaned by demisters (not shown) before passing into a condenser chamber (3) and condensing into product water (8), and thin metal plates (7) that separate boiling from condensing chambers. The advantageous features of a nested configuration such as described by FIG. 2 are numerous: (a) first, the energy for the entire system is provided in the center of the nested configuration and, thus, wall losses are minimized; (b) second, the nested arrangement of boilers and condensers with heat pipes to transfer the heat of condensation to the next boiler stage means that nearly all of the heat requirement for successive boiling is available by high-performance heat transfer devices that are far superior to conventional heat exchangers; (c) third, the thin wall separating boilers and condensers which is possible because the temperature (and thus the pressure) difference between stages is very small, also means that heat can transfer by thermal conductivity, thus reducing the number of heat pipes required; (d) fourth, the gradual decrease in both temperature and pressure as the number of stages increases means that the outer boiler and condenser are at the lowest temperature consistent with boiling, thus minimizing wall losses again.

It should be clear to those familiar with the art that the number of heat pipes required is a function of the size of the desalination system, and the surface area that is needed for heat transfer. One of the advantages of the nested design configuration is that the number of heat pipes required may be greatly reduced, or the need for heat pipes even eliminated if the surface area for transferring heat between stages is sufficiently high. Nevertheless, adding heat pipes to such heat transfer can enhance the thermal performance of the system. It should also be clear to those familiar with the art that thermosphyons, heat spreaders or a number of other types of heat transfer devices can be used instead of or in addition to heat pipes.

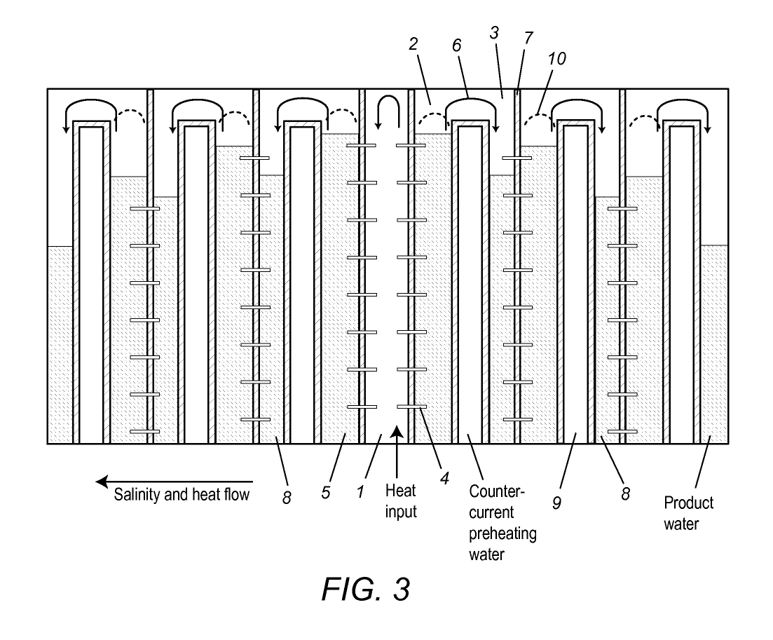

FIG. 3 illustrates an alternative embodiment of a nested concentric configuration. Preheated and degassed water (5) that enters boiler (2) is further heated to boiling by heat pipes (4) that transfer the heat from the central heating chamber (1). The steam (6) produced in boiler (2) is cleaned in a demister (10) that is described below and is condensed into product water (8) in condenser (3). As water is evaporated in each concentric boiler (2) the concentration of dissolved salts increases. The level of boiling water in each concentric boiler (2) is maintained at a constant level by a pressure regulator (not shown), which allows water to flow from each boiler to the next by the pressure differential between these boilers.

Another feature of the embodiment of FIG. 3 is the use of intermediate water pre-heating chambers (9) that are also concentric to the boilers and condensers and that take advantage of the high thermal conductivity of thin metal plates (7) that separate boiling and condenser chambers, so as to ensure that the heat contained in the product water (8) be recovered for recycling as preheated incoming water. If necessary, the metal plate separating the pre-heating chamber from the adjacent boiler can be coated with a thermal insulator to prevent heat losses in the boiling chamber. Suitable thermal insulators include but are not limited to certain ceramic compositions that are also impervious to high-salinity waters, such as alumina, zirconia, and similar metal oxides or nitrides.

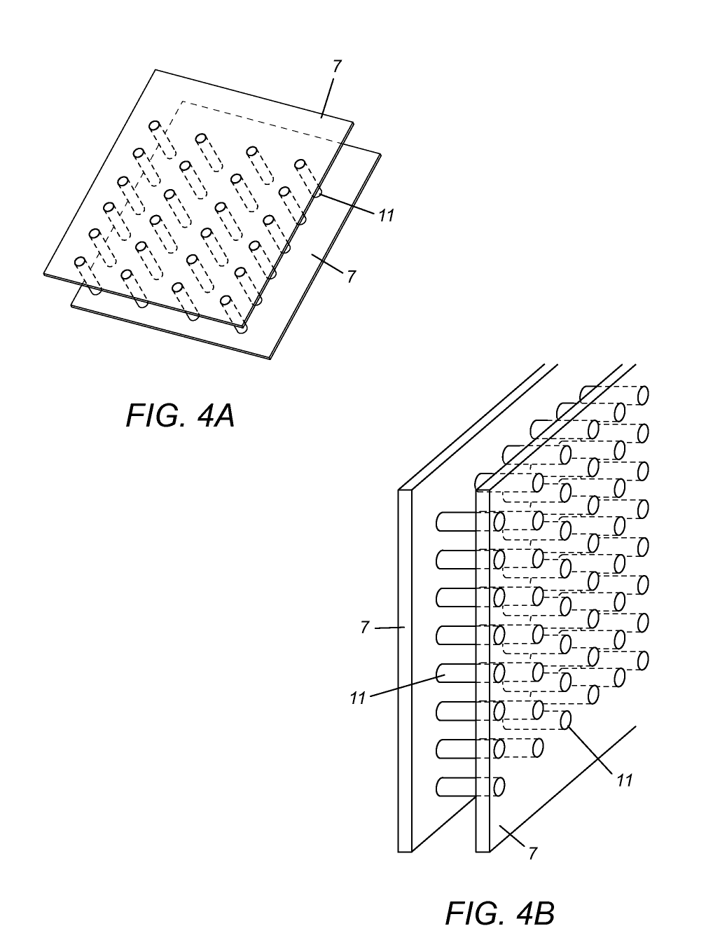

FIG. 4 describes an optional method for assembling concentric boilers and condensers that maintains rigidity and mechanical strength when the plates separating such boiler and condenser chambers are thin. The method consists of using small tubes (11) for separating the plates (7) which can be installed on a flat plane and subsequently formed into cylindrical surfaces to manufacture the boiler and condenser chambers.

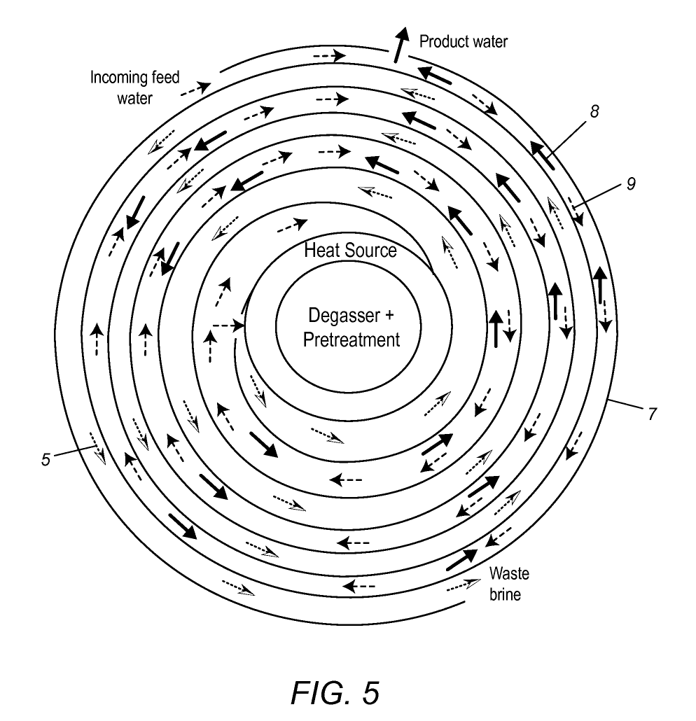

FIG. 5 illustrates an alternative embodiment of a nested configuration, one that is based on a continuous spiral with or without intermediate pressure regulators that may lower the pressure between one set of boiler and the adjacent one that surrounds it. One specific alternative embodiment is the use of a “Fermat” spiral, which is characterized by spirals [separated by a thin wall (7)] that become progressively thinner as their distance from the center increases, and thus allow for a greater evaporation surface near the center where heat is available at higher temperature for more efficient boiling action. For this reason, the spiral used for preheating incoming brine can be divided into two sections: one dedicated to carry the incoming brine (9) to be progressively preheated, and one dedicated to collect the product water (8) that exchanges heat with the incoming brine and thus becomes progressively cooler. The center of the spiral contains an area that can be used for degassing, pre-treatment, or similar function. Immediately surrounding this inner section there is an annulus for the heat input that can include low-pressure steam, waste heat, or combustion gases. The incoming preheated brine (9) enters the inner boiling area proximate to the heat source and evaporates into steam that then condenses into product water (8). The heat of condensation of this steam is transferred via heat pipes (not shown) into the adjacent boiler section, and this process is repeated until the salinity of the waste brine get close to the solubility limit of the soluble salts in that brine, at which point the waste brine is either discharged or subjected to additional cooling before final discharge.

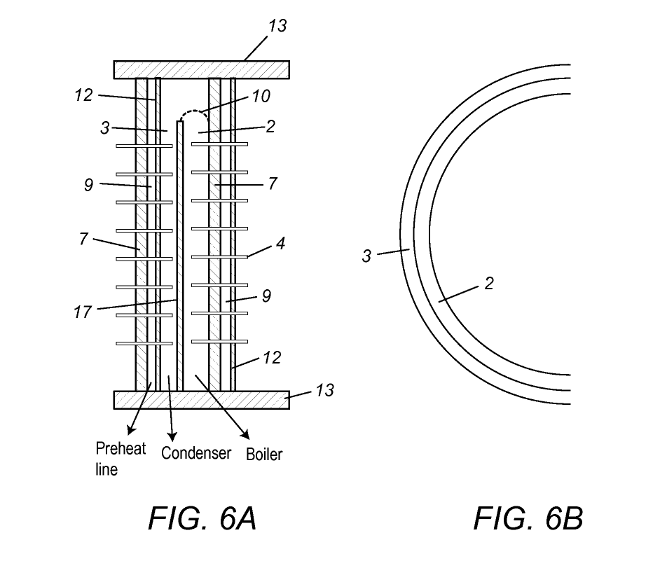

FIG. 6 illustrates a cross-sectional and a plan view of a boiler (2) and condenser (3) with an alternative embodiment to that shown in FIG. 3. In FIG. 6, the boiler (2) and condenser (3) sections are separated by a thin plate (17) that is open on the top to allow the passage of steam. A demister (10) placed on top of the metal plate (17) separates clean steam from water droplets that may be entrained by the boiling action. The steam condenses in the condenser section (3) and the heat of condensation is efficiently transferred by heat pipes (4) to an adjacent boiling section that surrounds the condenser (3) and a narrow preheating chamber (9). The section of the heat pipe (4) that traverses the preheating chamber (9) may be thermally insulated to prevent thermal losses during the transfer of heat from the condenser (3) to the surrounding boiler (2). A thin metal plate (12) separates the condenser chamber (3) from the preheating chamber (9), so that the condensed product water may transfer heat to the preheating chamber (9) by thermal conductivity. Two thicker vertical metal plates (7) separate the boiler and condenser chambers from the surrounding distillation and condensing stages, and two horizontal plates (13) seal the top and bottoms of each distillation and condensing stages. The thickness of plates (7) and (13) is sufficient to withstand the pressure differential between adjacent boiling and condensation stages.

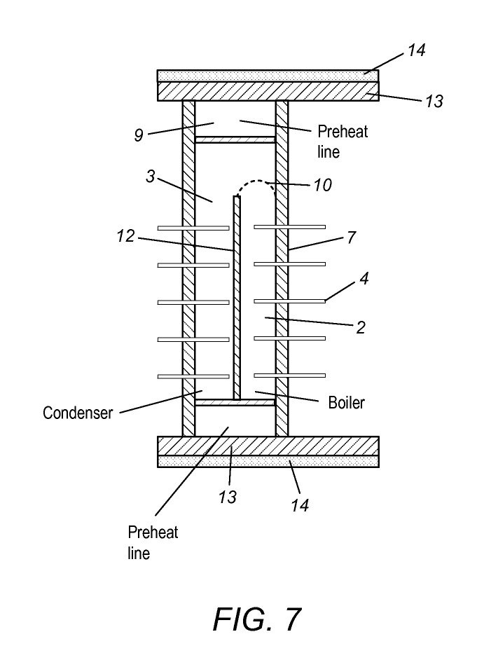

FIG. 7 shows a cross section of a slightly different embodiment for a boiler (2) and condenser (3) stage in a nested configuration. In FIG. 7, the preheating chamber (9) is located adjacent to the bottom and top plates (13) in order to reduce thermal wall losses. In this particular embodiment, the vertical plates (7) that separate individual stages do not require thermal insulation, but the top and bottom plates (13) have an insulating layer (14). As in the case of FIG. 6, a demister (10) is placed proximate the top of the boiling chamber, and heat pipes (4) transfer the heat of condensation to the adjacent boiling stage.

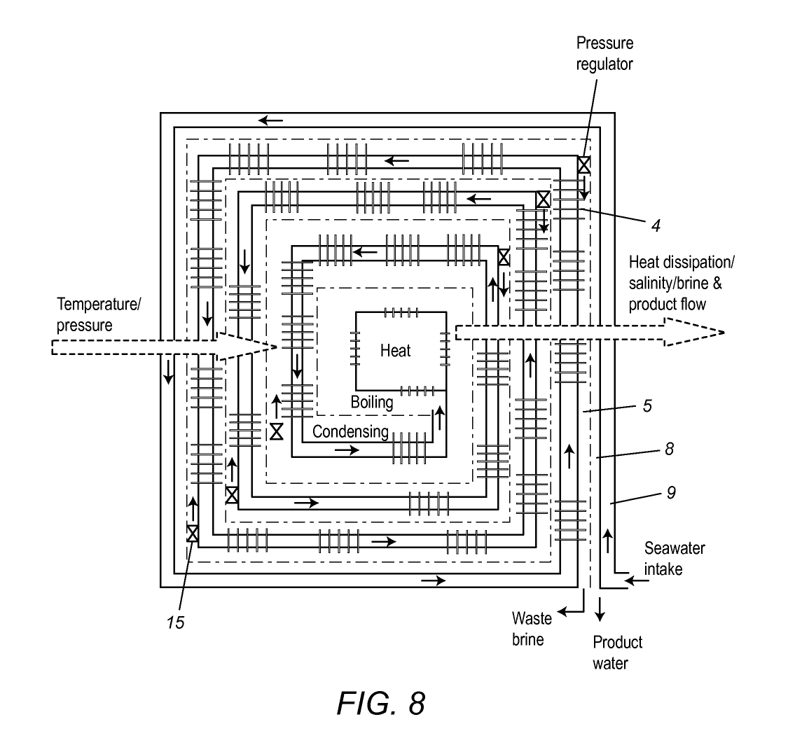

FIG. 8 illustrates an alternative embodiment of a nested configuration where the concentric arrangement of distillation and condensing stages are not circular but rectangular. In FIG. 8, the incoming saline brine enters through a preheating chamber (9) and flows inward becoming increasingly hotter until it reaches the center of the nested configuration where heat energy is provided. At the inner boiling stage, the preheated incoming water boils and the steam is condensed in the outer condenser chamber into product water (8), thereby transferring the heat of condensation to the next boiling chamber by means of heat pipes (4) and thermal conductivity. A pressure regulator (15) between stages controls the gradual decrease in pressure from the inner boiling chamber to the outer perimeter. As boiling concentrates the saline brine, it becomes increasingly saturated with soluble salts but at levels that do not exceed their solubility limit and eventually is discharged as waste brine (5).

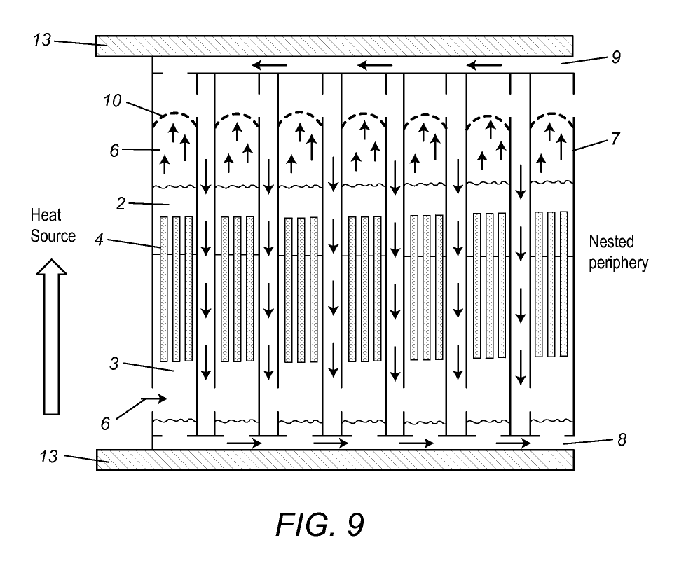

FIG. 9 shows an alternative cross-sectional view of a nested configuration. In FIG. 9, a set of either concentric boilers or a spiral boiler (2), is mounted on top of concentric or a spiral condenser (3), such that at the junction between boilers and condenser chambers a set of heat pipes (4) transfer the heat of condensation from a condenser chamber into a boiler chamber. During boiling, steam (6) is generated and such steam is cleaned by a demister (10). A series of plates (7) separate different boiler and condenser stages. The center of the nested configuration contains the heat source, and the periphery marks the external boundary of the nested configuration, which is close to ambient temperature. Incoming contaminated water (9) enters at the periphery and is preheated near its boiling point by heat that is transferred from the steam (6) in the boiling chambers (2). Steam (6) that condenses in the condenser chambers becomes product water (8) and exists at the bottom of the nested configuration. Bottom and top plates (13) prevent leakage and provide the necessary thermal insulation for the entire system. Boiling concentrates the salinity of the incoming water as it moves from near the center toward the periphery of the system (not shown in FIG. 9).

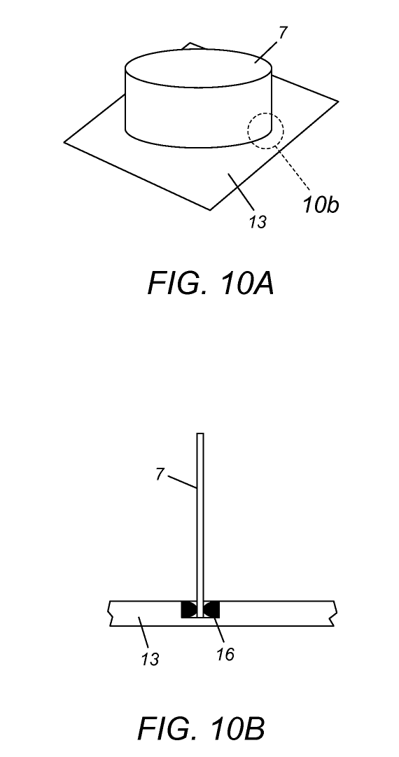

FIG. 10 is a schematic diagram that illustrates a method for assembling a nested configuration of boilers and condensers when using thin plates for separating multiple distillation stages. In FIG. 9, a vertical plate (7) can be secured against the mounting plate (13) by pressing down until two concentric rubber rings (16), or the like, engage and provide a seal that does not leak. This is an optional alternative to welding or similar methods of sealing dissimilar plates, but one that lends itself well to easy maintenance and repair.

One skilled in the art will appreciate that these methods and devices are and may be adapted to carry out the objects and obtain the ends and advantages mentioned, as well as various other advantages and benefits. The methods, procedures, and devices described herein are presently representative of preferred embodiments and are exemplary and are not intended as limitations on the scope of the invention. Changes therein and other uses will occur to those skilled in the art which are encompassed within the spirit of the invention and are defined by the scope of the disclosure.

### Efficient Heat Transfer Mechanisms

An important advantage of the system described herein is the heat transfer mechanism by using heat pipes. Heat pipes provide a means of transferring heat that is near thermodynamically reversible, i.e., that is, as system that transfer enthalpy with almost no losses in efficiency. Thus, with the exception of the pre-heating energy which is largely but not entirely recovered from the heat of the product water, nearly all of the heat provided by the heat input section at the center of the nested configuration is re-used at each of the boiling and condensing stages by minimizing heat losses at the system surface. Since that surface is minimized in a nested configuration, and since that surface can be surrounded by preheating the incoming water that is at ambient temperature, the amount of heat lost due to surface losses can be close to zero. Therefore, the energy used during multiple stages of boiling and condensing can be readily approximated by dividing the heat of evaporation of water by the number of stages of the system.

Clearly, it is advantageous to be able to maximize the number of boiling and condensing stages in the present invention, and heat pipes allow this to be done, provided that the temperature difference between the condensing and boiling ends of such a heat pipe (the ΔT) be sufficient to maintain the maximum heat flux through the heat pipe. Commercially available heat pipes typically have ΔTs of the order of 8 C (15 F), although some have ΔTs as low as 3 C. The ΔT defines the maximum number of stages that are practical with a given amount of heat available at a given temperature. Thus, there is a need for heat pipes that can function with as small a ΔT as possible. It is therefore useful to examine the thermal phenomena in a heat pipe.

A commercial heat pipe ordinarily consists of a partially evacuated and sealed tube containing a small amount of a working fluid which is typically water, but which may also be an alcohol or other volatile liquid. When heat is applied to the high-temperature end in the form of enthalpy, the heat first crosses the metal barrier of the tube and then is used to provide the heat of vaporization to the working fluid. As the working fluid evaporates, the resulting gas (steam in the case of water) fills tube and reaches the low-temperature end where the lower temperature causes condensation and, thus, release of the same heat as the heat of condensation. To facilitate continuous operation, the inside of tube normally includes a wick which can be any porous and hydrophilic layer that transfers the condensed phase of the working fluid back to the hot end of the tube by capillary action.

Experimentally, the largest barriers to heat transfer in a heat pipe include: first the layer immediately adjacent to the outside of the heat pipe, second the conduction barrier presented by the material of the heat pipe, and third, the limitation of the wick material to return working fluid to the hot end of the heat pipe. Heat pipes are extensively used in a number of heat transfer applications, such as the Alaska oil pipeline, in satellites, for cooling IC chips in computers, and similar applications, but generally have not been used for desalination or water purification applications, except those filed and patented by Sylvan Source Inc. Heat pipes are vastly superior to heat exchangers for transferring heat. Independent studies at UCLA, SRI International and ARPA-E have shown heat pipes to be several thousand and up to 30,000 times more conductive than silver with similar dimensions.

In addition, significant improvements have been made in high-performance heat pipes that are able to transfer up to 200 Watt per heat pipe with temperature differences as low as 3-4° C. Further advances in heat pipe design and manufacture have been proposed by Thiers (U.S. Pat. No. 8,771,477; 0088520-018WO0 entitled “INDUSTRIAL WATER PURIFICATION AND DESALINATION,” Application No.: PCT/US12/54221, filing date: Sep. 7, 2012; and U.S. Provisional Application No. 62/041,556). Each of the foregoing patent and applications is hereby incorporated by reference in its entirety.

Even with conventional/commercial heat pipes, the low heat losses brought about by the compact nested configurations allow extremely efficient desalination systems. In a circular concentric configuration with 14 stages treating seawater, the net energy consumption can be as low as 4.5 kWh/m3 of product water. Lower energy levels can be achieved with high-performance heat pipes.

The invention illustratively described herein suitably can be practiced in the absence of any element or elements, limitation or limitations which are not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the disclosure.

Those skilled in the art recognize that the aspects and embodiments of the invention set forth herein can be practiced separate from each other or in conjunction with each other. Therefore, combinations of separate embodiments are within the scope of the invention as disclosed herein.

All patents and publications are herein incorporated by reference to the same extent as if each individual publication was specifically and individually indicated to be incorporated by reference.

1. A water purification and desalination system comprising a nested arrangement of boilers and condensers wherein the system is capable of removing, from a contaminated water sample, a plurality of contaminant types including: microbiological contaminants, radiological contaminants, metals, and salts, while recovering the energy of distillation once or multiple times; wherein the system comprises one or more heat transfer devices selected from the group consisting of heat pipes, thermosiphons, and heat spreaders.

2. The system of claim 1, wherein energy is provided to the system from an energy source selected from the group consisting of electricity, geothermal, solar energy, steam, coal, oil, hydrocarbons, natural gas, waste heat, working fluid from recuperators, solar heaters, economizers, and the like, and any combination thereof.

3. The system of claim 1, wherein the water sample is selected from the group consisting of tap water, industrial waste water, municipal waste water, seawater, saline brines and waters contaminated by agricultural activities, gasoline additives, heavy toxic metals, germs, bacteria, or salts.

4. (canceled)

5. The system of claim 1, wherein the desalination section comprises an inlet, a preheater, a degasser, one or more evaporation chambers, one ore more demisters, one or more product condensers, a waste outlet, a one or more product outlets, a heating chamber, and a control system.

6. The system of claim 5, wherein water purified in the system has levels of all contaminant types below the levels shown in Table 1, when the contaminated water has levels of the contaminant types that are up to 20,000 times greater than the levels shown in Table 1.

7. The system of claim 1, wherein a volume of water produced is between about 20% and about 99% of a volume of input water.

8. The system of claim 1, wherein the system does not require cleaning through at least one month of continuous use.

9. (canceled)

10. (canceled)

11. The system of claim 1, comprising a nested configuration of concentric circular tanks, rectangular tanks, or spiral tanks.

12. The system of claim 11, wherein the incoming saline water flows inward and is preheated, the heat energy flows outward together with the product water, and waste brine is progressively concentrated and peripherally discharged.

13. (canceled)

14. (canceled)

15. The system of claim 5, wherein the heating chamber is located at a center of a nested arrangement of boilers and condensers.

16. The system of claim 5, wherein the demister is positioned proximate to the evaporation chamber.

17. The system of claim 5, wherein steam from the evaporation chamber enters the demister under pressure.

18. A method of purifying and desalinating water using the system of claim 1, comprising the steps of:
preheating incoming contaminated water, the water comprising at least one contaminant in a first concentration;
maintaining the water in an evaporation chamber, under conditions permitting formation of steam;
condensing the clean steam to yield purified water, comprising at least one contaminant in a second concentration, wherein the second concentration is lower than the first concentration;
recovering and transferring heat (the heat of condensation) from a condenser chamber into an adjacent boiling or pre-heating chamber;
repeating the evaporation and condensation multiple times in order to re-use the energy while maximizing clean water production.

19. The method of claim 18, wherein the amount of heat recovered is at least 80% of the heat of condensation in each boiling and condensing cycle.

20. The method of claim 18, wherein the amount of heat recovered is greater than 90% of the heat of condensation in each boiling and condensing cycle.

21. The method of claim 18 comprising additional steps of:
discharging steam from the evaporation chamber to a demister;
separating clean steam from contaminant-containing waste in the demister; and
repeating the evaporation and condensation multiple times.

22. The method of claim 18, wherein a nested arrangement of boilers, condensers, and preheater chambers is enclosed in a metal shell with thermal insulation.

23. The system of claim 1, further comprising a pre-treatment section.

24. The system of claim 1, wherein the system uses heat transfer by thermal conductivity through the wall(s) separating boiler(s) and condensers.
